(19) United States
(12) Patent Application Publication
(10) Pub. No.: US 2008/0278521 A1
(43) Pub. Date: Nov. 13, 2008

(54) Display device and driving method thereof

(76) Inventor: Hyun-Chang Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,758

(22) Filed: Apr. 21, 2008

(30) Foreign Application Priority Data
May 9, 2007 (KR) 10-2007-0045002

(51) Int. Cl. G09G 3/20; G09G 5/10

(52) U.S. Cl. 345/690; 345/55

(57) ABSTRACT

Example embodiments relate to a display device and a method for driving the same. The method may include receiving an input signal from a user, determining whether the input signal is in a normal state or a degree of color deficiency, and changing a gamma coefficient of the input signal according to the user's state.

### BACKGROUND OF THE INVENTION

1. Field of the Invention

Example embodiments relate to a display device and a driving method thereof.

2. Description of the Related Art

Recently, flat panel displays, e.g., a liquid crystal display (LCD), a field emission display (FED), a plasma display device, and the like, have been actively developed. The plasma display device may be advantageous over the other flat panel displays due to its properties, e.g., high luminance, high luminous efficiency, and wide view angle. As result, the plasma display device may be more desirable in making large-scale display devices, e.g., more than 40 inches, as a substitute for conventional cathode ray tubes (CRT).

Further, the plasma display device may have to reproduce same color tones as those of the CRT in order to be a viable substitute for the existing CRT. However, an output amount of light produced by an applied voltage generated by a signal, e.g., a video signal, in the plasma display device may be different from the CRT, and thereby requiring a correction so that the output amount of light of the plasma display device may be the same as that of the CRT.

Accordingly, in order to correct the output amount of light, a gamma coefficient may be calculated. The gamma coefficient may be calculated by a ratio between an input video signal and an output. The gamma coefficient of the CRT may be approximately 2.2, and in other display devices, a gamma correction may be required so that a value may become a basic gamma coefficient of 2.2.

Generally, most display device may perform a function to correct the basic gamma coefficient (e.g., 2.2) for a person having normal vision. However, observers with difficulty in color vision may not be able to view normal images through plasma display devices. Color vision deficiency may mean that one's ability to distinguish some colors may be less than normal or may not exist, which may be due to a deficiency or absence of cone cells in a retina of an eye.

Further, color vision deficiency may be divided into color weakness and color blindness. Color weakness may mean that, although a person may have all three cone cells of red (R), green (G), and blue (B), the person may not be able to distinguish the color when the corresponding color is mixed with other colors because the functions of one or two or more cone cells may be reduced. Color blindness may mean that a person may observe only two colors because one of the three cone cells of red (R), green (G), and blue (B) may be absent.

A conventional display device may perform the gamma correction of a video signal input by using the basic gamma coefficient (2.2) corresponding to a person having normal vision. However, when a color deficient observer views a gamma corrected video signal, the person may not still be able to distinguish between the colors during viewing, and thus, perceiving a poor picture quality.

The above information disclosed in the Background section is only for enhancement of understanding the background of the invention, and therefore it may contain information that may not form the prior art that may be already known to a person of ordinary skill in the art.

### SUMMARY OF THE INVENTION

Example embodiments are therefore directed to display device and method thereof, which substantially overcome one or more of the problems due to the limitations and disadvantages of the related art.

It is a feature of example embodiments to improve picture quality by adjusting elements affecting picture quality according to a degree of color vision deficiency.

At least one of the above and other features of exemplary embodiments may be to provide a method for driving a display device. The method may include receiving an input signal from a user, determining whether the input signal is in a normal state or a degree of color deficiency, and changing a gamma coefficient of the input signal according to the user's state.

The method may include, if the degree of color vision deficiency of the user is normal, setting the gamma coefficient of a first color, a gamma coefficient of a second color, and a gamma coefficient of a third color as basic gamma coefficients, and gamma-correct the input signal.

The method may include, if the degree of color vision deficiency of the user is not normal, changing at least one of the gamma coefficient of a first color, the gamma coefficient of a second color, and the gamma coefficient of a third color depending on the degree of color vision deficiency.

The method may include, if the degree of color vision deficiency is a first color weakness, changing the gamma coefficient of a first color to a higher value. The gamma coefficient of the first color may include one of a red gamma coefficient, a green gamma coefficient, and a blue gamma coefficient.

The method may include, if the degree of color vision deficiency is a first color blindness, changing the gamma coefficient of a first color to a higher value. The gamma coefficient of the first color may include one of a red gamma coefficient, a green gamma coefficient, and a blue gamma coefficient.

The method may include transmitting a gamma table selection signal to one least one of a plurality of gamma tables.

At least one of the above and other features of exemplary embodiments may be to provide a display device, having a display panel adapted to display a video signal, a driver adapted to drive the display panel, and a controller adapted to receive an input signal from a user so as to determine whether the input signal is in a normal state or a degree of color in deficiency, and changing a gamma coefficient of the input signal according to the user's state.

The controller may further include a user signal determination unit adapted to receive the input signal to determine the normal state or the degree of color vision deficiency, a gamma setting unit adapted to correct the gamma coefficient according to the result of determination of the user signal determination unit, and adapted to set the same, and a plurality of gamma tables adapted to gamma-correct the video signal to the set gamma coefficient, and adapted to output the same.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a schematic view of a display device according to an example embodiment;

FIG. 2 illustrates a schematic view of a gamma corrector of a display device according to an example embodiment;

FIG. 3 illustrates a view of a gamma curve in a normal state according to an example embodiment;

FIG. 4 illustrates a view of a corrected gamma curve in a red color vision deficiency according to an example embodiment;

FIG. 5 illustrates a view of a corrected gamma curve in a green color vision deficiency according to an example embodiment;

FIG. 6 illustrates a view of a corrected gamma curve in a blue color vision deficiency according to an example embodiment;

FIG. 7 illustrates a view of a corrected gamma curve in a red blindness according to an example embodiment;

FIG. 8 illustrates a view of a corrected gamma curve in a green blindness according to an example embodiment;

FIG. 9 illustrates a view of a corrected gamma curve in a blue blindness according to an example embodiment; and

FIG. 10 illustrates a view of an operation of a gamma corrector in a display device according to an example embodiment.

### DETAILED DESCRIPTION OF THE INVENTION

Korean Patent Application No. 10-2007-0045002 filed on May 9, 2007, in the Korean Intellectual Property Office, and entitled: “Display Device and Driving Method Thereof,” is incorporated by reference herein in its entirety.

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

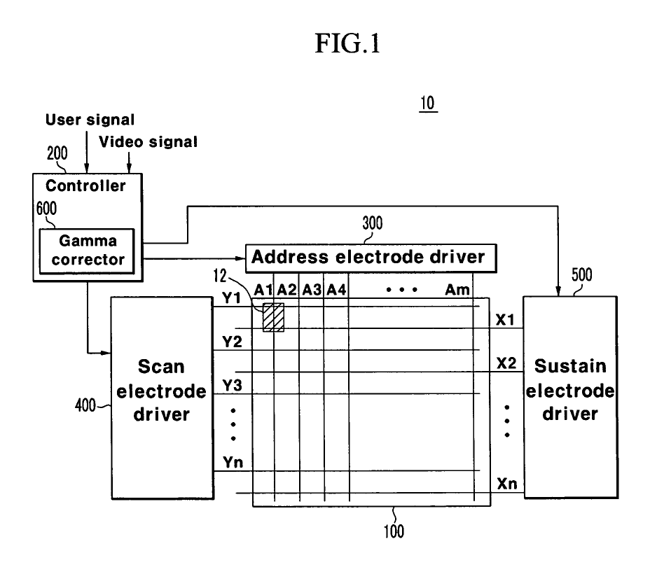

FIG. 1 illustrates a schematic view of a display device 10 according to an example embodiment.

Referring to FIG. 1, the display device 10 may include a display panel 100, a controller 200, an address electrode driver 300, a scan electrode driver 400, and a sustain electrode driver 500. It should be appreciated that other elements and/or devices may be incorporated in the display device 10.

The display panel 100 may include a plurality of address electrodes μl to Am extending in a column direction, and a plurality of sustain and scan electrodes X1 to Xn and Y1 to Yn extending in a row direction by pairs. The sustain electrodes X1 to Xn may be formed to correspond to the respective scan electrodes Y1 to Yn. Discharge spaces at intersections between the address electrodes μl to Am and the sustain and scan electrodes X1 to Xn and Y1 to Yn may form discharge cells 12 (hereinafter, “cells”). It should be appreciated that the display panel 100 may be embodied as a plasma display panel (PDP). It should further be appreciated that other embodiments of the display device 100 may include other types of panels to which subsequent driving waveforms are applied.

The controller 200 may receive an external signal, (e.g., a video signal), and may output various signals, e.g., an address driving control signal, a sustain electrode driving control signal, and a scan electrode driving control signal. The controller 200 may receive an external user signal and may determine a user state. The controller 200 may include a gamma corrector 600 for performing gamma correction corresponding to the user state and correcting an input video signal. The controller 200 may output an address driving control signal, a sustain electrode driving control signal, and a scan electrode driving signal by using the corrected video signal. Further, the controller 200 may drive the plasma display device 10 by dividing a field into a plurality of subfields having respective brightness weight values.

The address electrode driver 300 may receive an address electrode drive control signal from controller 200, and may apply a display data signal for selecting discharge cells to be displayed to the respective address electrodes A1 to Am.

The scan electrode driver 400 may receive a scan electrode drive control signal from the controller 200, and may apply a driving voltage to the scan electrodes Y1 to Yn.

The sustain electrode driver 500 may receive the sustain electrode driving control signal from the controller 200, and may apply a driving voltage to the sustain electrodes X1 to Xn.

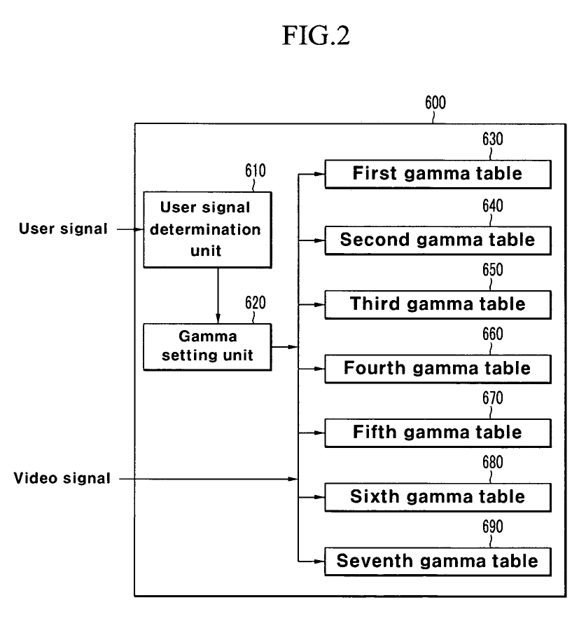

FIG. 2 illustrates a schematic view of the gamma corrector 600 of the display device 10 according to an example embodiment.

Referring to FIG. 2, the gamma corrector 600 may include a user signal determination unit 610, a gamma setting unit 620, a first gamma table 630, a second gamma table 640, a third gamma table 650, a fourth gamma table 660, a fifth gamma table 670, a sixth gamma table 680, and a seventh gamma table 690.

The user signal determination unit 610 may receive a user signal, and may determine a normal state (or a color vision deficiency). In an example embodiment, the color vision deficiency may correspond to color weakness or color blindness. The color weakness may include red weakness, green weakness, and/or blue weakness. The color blindness may include red blindness, green blindness, and/or blue blindness.

The user signal determination unit 610 may determine the normal state when receiving the user signal corresponding to a cone cell of the normal state. The cone cell may be a cell that may recognize a color depending on external light color and brightness. Alternatively, the user signal determination unit 610 may also determine the color vision deficiency when receiving the user signal corresponding to the cone cell of the color vision deficiency.

When there is a color vision deficiency, color weakness may be determined according to a degree of color weakness of cone cells when receiving the corresponding user signal, and color blindness may be determined according to an absence of cone cells when transmitting the corresponding user signal.

In an example embodiment, regarding color weakness, (e.g., when a reference degree of color weakness of the cone cell corresponding to the user signal is 1), if the red failure rate (F_R) is 0.9, the signal may be determined as red weakness; if the green failure rate (F_R) is 0.8, the signal may be determined as green weakness; and if the blue failure rate (F_B) is 0.7, the signal may be determined as blue weakness.

In an example embodiment, regarding color blindness, if there is no red cone cell of a user signal, the signal may be determined as red blindness; if there is no green cone cell, the signal may be determined as green blindness; and if there is no blue cone cell, the signal may be determined as blue blindness.

The gamma setting unit 620 may set a gamma coefficient corresponding to the result of determination of the user signal determination unit 610, and may transmit a gamma table selection signal to one of the first to seventh gamma tables 630, 640, 650, 660, 670, 680, and 690.

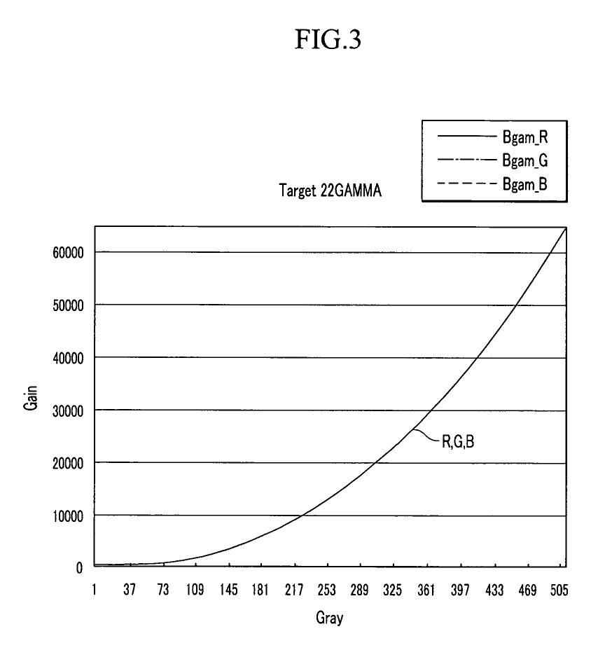

In a normal state, the gamma setting unit 620 may set a gamma coefficient as a basic gamma gain (e.g., gamma coefficient 2.2), and may transmit a gamma table selection signal to transmit a basic red gamma value, a basic green gamma value, and a basic blue gamma value to the first gamma table 630. The gamma gain (or gamma coefficient) may indicate the brightness of an image, and may be indicated by a slope of a line representing an input value (Gray) relative to an output value (Gain) (as shown in FIG. 3).

Although the basic red gamma value, the basic red gamma value, and the basic blue gamma value may be set to the basic gamma coefficient (2.2), it should be appreciated that the gamma values may be changed to other gamma coefficients according to a user's convenience.

In case of red weakness, the gamma setting unit 620 may correct the red gamma coefficient for setting the same, and may transmit a gamma table selection signal to the second gamma table 640. The red corrected gamma value may be obtained by correcting the red gamma coefficient and multiplying the red gamma value by a red weakness multiplier, e.g., 1.1. The green corrected gamma value and the basic green gamma value may be the same, and the blue corrected gamma value and the basic blue gamma value may be the same.

In a case of green weakness, the gamma setting unit 620 may correct the green gamma coefficient for setting the same, and may transmit a gamma table selection signal to the third gamma table 650. The green corrected gamma value may be obtained by correcting the green gamma coefficient and multiplying the green gamma value by a green weakness multiplier, e.g., 1.25. The red corrected gamma value and the basic red gamma value may be the same, and the blue corrected gamma value and the basic blue gamma value may be the same.

In the case of blue weakness, the gamma setting unit 620 may set the blue gamma coefficient for setting the same, and may transmit a gamma table selection signal to the fourth gamma table 660. The blue corrected gamma value may be obtained by correcting the blue gamma coefficient and multiplying the basic blue gamma value by a blue weakness multiplier, e.g., 1.43. The red corrected gamma value and the basic red gamma value may be the same, and the green corrected gamma value and the basic green gamma value may be the same.

In the case of red blindness, the gamma setting unit 620 may correct the red gamma coefficient for setting the same, and may transmit a gamma table selection signal to the fifth gamma table 670. The red corrected gamma value may be obtained by correcting the red gamma coefficient and adding a red blindness offset, e.g., 1000, to the basic red gamma value. The green gamma value and the basic green gamma value may be the same, and the blue corrected gamma value and the basic blue gamma value may be the same.

In the case of green blindness, the gamma setting unit 620 may correct the green gamma coefficient for setting the same, and may transmit a gamma table selection signal to the sixth gamma table 680. The green corrected gamma value may be obtained by correcting the green gamma coefficient and adding a green blindness offset, e.g., 3000, to the basic green gamma value. The red corrected gamma value and the basic red gamma value may be the same, and the blue corrected gamma value and the basic blue gamma value may be the same.

In the case of blue blindness, the gamma setting unit 620 may correct the blue gamma coefficient for setting the same, and may transmit a gamma table selection signal to the seventh gamma table 690. The blue corrected gamma value may be obtained by correcting the blue gamma coefficient and adding a blue blindness offset, e.g., 4000, to the basic blue gamma value. The red corrected gamma value and the basic red gamma value may be the same, and the green corrected gamma value and the basic green gamma value may be the same.

When a gamma coefficient is corrected in the gamma setting unit 620, a coefficient value to be multiplied and/or added to at least one of the basic red gamma value, the basic green gamma value, and the basic blue gamma value may be changed according to a user's convenience.

FIG. 3 illustrates a view of a gamma curve in a case of a normal state according to an example embodiment.

In the normal state, the first gamma table 630 may respond to a gamma table selection signal transmitted from the gamma setting unit 620, and may output a gamma corrected video signal as a set basic gamma coefficient (2.2).

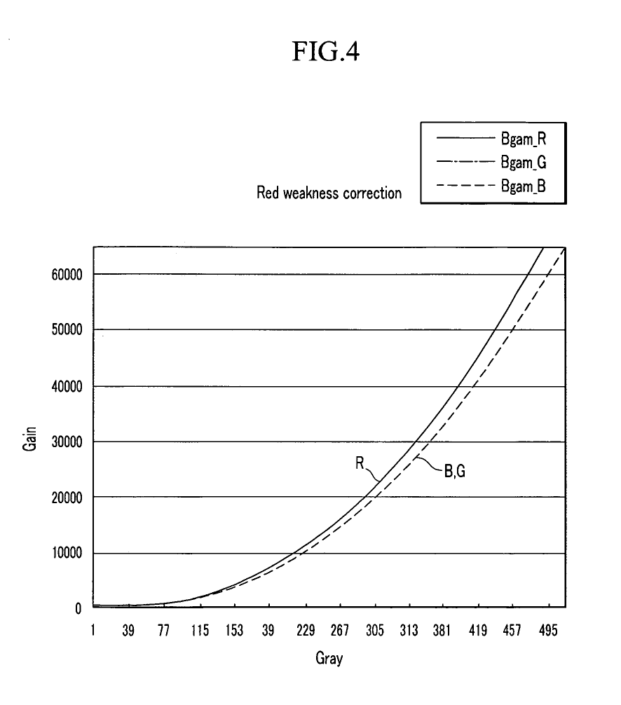

FIG. 4 illustrates a view of a corrected gamma curve in the case of red color vision deficiency according to an example embodiment.

In the case of red weakness, the second gamma table 640 may respond to a gamma table selection signal transmitted from the gamma setting unit 620, and may output a gamma corrected video signal as a set red gamma coefficient, e.g., the red gamma curve may be shifted from the blue and green gamma curves by the red blindness multiplier.

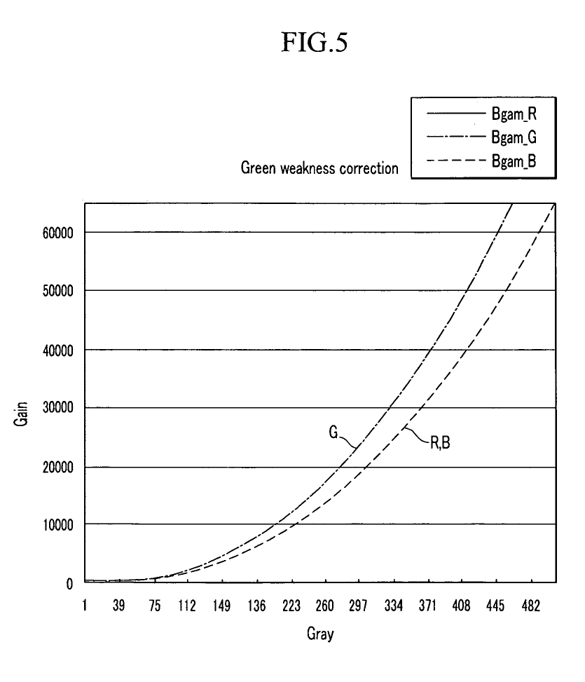

FIG. 5 illustrates a view of a corrected gamma curve in the case of green color vision deficiency according to an example embodiment.

In case of green weakness, the third gamma table 650 may respond to a gamma table selection signal transmitted from the gamma setting unit 620, and may output a gamma corrected video signal as a set green gamma coefficient, e.g., the green gamma curve may be shifted from the red and blue gamma curves by the green blindness multiplier.

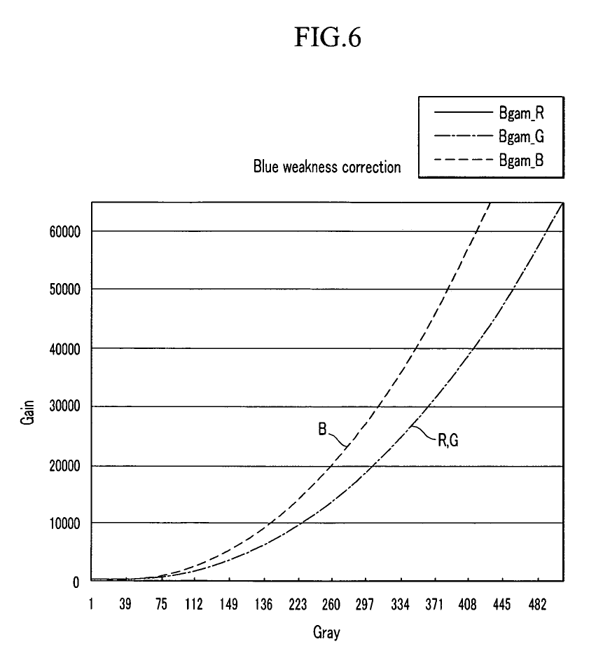

FIG. 6 illustrates a view of a corrected gamma curve in the case of blue color vision deficiency according to an example embodiment.

In the case of blue weakness, the fourth gamma table 660 may respond to a gamma table selection signal transmitted from the gamma setting unit 620, and may output a gamma corrected video signal as a set blue gamma coefficient, e.g., the blue gamma curve may be shifted from the red and green gamma curves by the blue blindness multiplier.

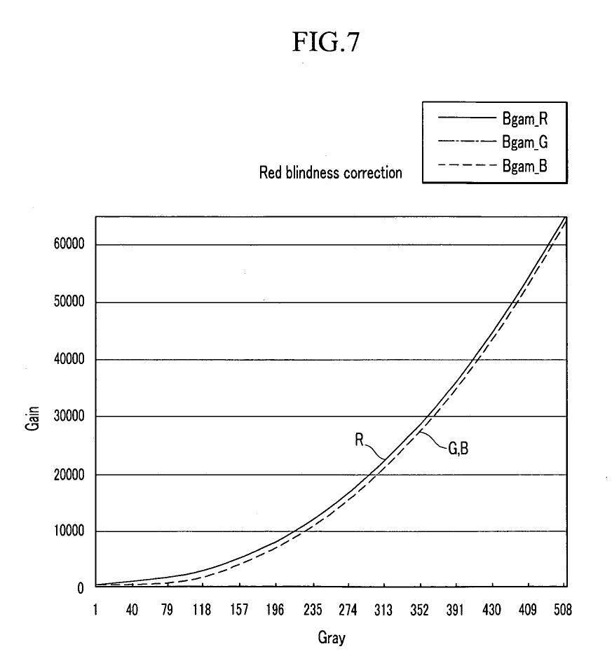

FIG. 7 illustrates a view of a corrected gamma curve in the case of red blindness according to an example embodiment.

In the case of red blindness, the fifth gamma table 670 may respond to a gamma table selection signal transmitted from the gamma setting unit 620, and may output a gamma corrected video signal as a set red gamma coefficient, e.g., the red gamma curve may be offset from the green and blue gamma curves by the red gamma offset.

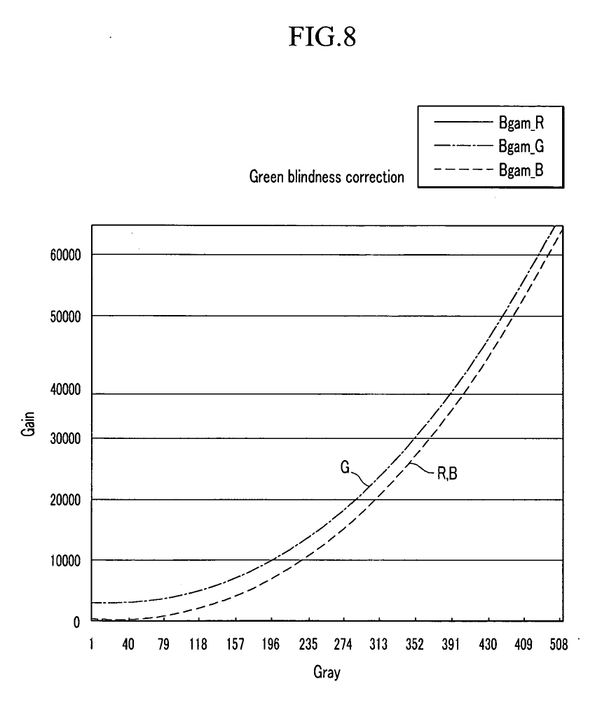

FIG. 8 illustrates a view of a corrected gamma curve in the case of green blindness according to an example embodiment.

In the case of green blindness, the sixth gamma table 680 may respond to a gamma table selection signal transmitted from the gamma setting unit 620, and may output a gamma corrected video signal as a set green gamma coefficient, e.g., the green gamma curve may be offset from the red and blue gamma curves by the green gamma offset.

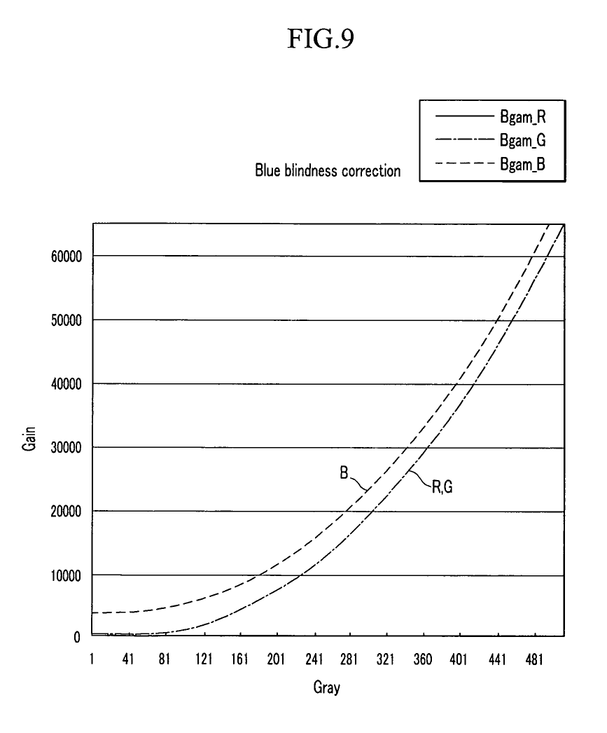

FIG. 9 illustrates a view of a corrected gamma curve in the case of blue blindness according to an example embodiment.

In the case of blue blindness, the seventh gamma table 690 may respond to a gamma table selection signal transmitted from the gamma setting unit 620, and may output a gamma corrected video signal as a set blue gamma coefficient, e.g., the blue gamma curve may be offset from the red and green gamma curves by the blue gamma offset.

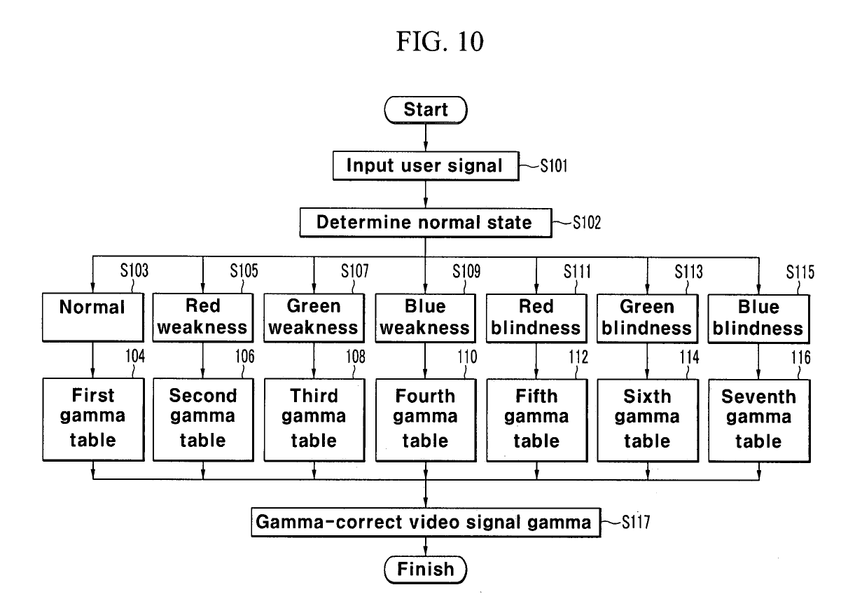

FIG. 10 illustrates a view of an operation of a gamma corrector in a display device according to an example embodiment.

Referring to FIGS. 2 and 10, the gamma corrector 600 may receive an external user signal (S101). The user signal determination 610 unit may receive a user signal and may determine a normal state (or a color vision deficiency) (S102).

As a result of determination in S102, the user signal determination unit 610 may determine a user signal as normal (S103). When the user signal is determined as normal in S103, the gamma setting unit 620 may set a gamma coefficient as a basic gamma coefficient (2.2). The gamma setting unit 620 may transmit a gamma table selection signal for transmitting a basic red gamma value, a basic green gamma value and a basic blue gamma value corresponding to the basic gamma coefficient to the first gamma table 630 (S104).

The user signal determination unit 610 may further determine a user signal as red weakness (S105). When the user signal is determined as red weakness in S105, the gamma setting unit 620 may set a red gamma coefficient for setting the same. The gamma setting unit 620 may then transmit a gamma table selection signal to the second gamma table 640 (S106).

The user signal determination unit 610 may further determine a user signal as green weakness (S107). When the user signal is determined as green weakness in S107, the gamma setting unit 620 may set a green gamma coefficient for setting the same. The gamma setting unit 620 may then transmit a gamma table selection signal to the third gamma table 650 (S108).

The user signal determination unit 610 may further determine a user signal as blue weakness (S109). When the user signal is determined as blue weakness in S109, the gamma setting unit 620 may set a blue gamma coefficient for setting the same. The gamma setting unit 620 may then transmit a gamma table selection signal to the fourth gamma table 660 (S110).

The user signal determination unit 610 may further determine a user signal as red blindness (S111). When the user signal is determined as red weakness in S111, the gamma setting unit 620 may set a red gamma coefficient for setting the same. The gamma setting unit 620 may then transmit a gamma table selection signal to the fifth gamma table 670 (S112).

The user signal determination unit 610 may further determine a user signal as green blindness (S113). When the user signal is determined as green blindness in S113, the gamma setting unit 620 may set a green gamma coefficient for setting the same. The gamma setting unit 620 may then transmit a gamma table selection signal to the sixth gamma table 680 (S114).

The user signal determination unit 610 may further determine a user signal as blue blindness (S115). When the user signal is determined as blue blindness in S115, the gamma setting unit 620 may set a blue gamma coefficient for setting the same. The gamma setting unit 620 may then transmit a gamma table selection signal to the seventh gamma table 690 (S116).

The gamma corrector 600 may then respond to a gamma table selection signal transmitted in at least one of S104, S106, S108, S110, S112, S114, and S116, and may gamma-correct the video signal input from the outside to a set gamma coefficient for setting the same (S117).

Although example embodiments have been described with respect to a display device, it may also be applicable to other display devices, such as, but not limited to, a CRT, a liquid crystal display (LCD), a field emission display (FED), a plasma display device, etc. The particular values of the gamma coefficients and their multipliers and offsets may be appropriately adjusted. Further, more than one color weakness and/or blindness may be compensated.

Accordingly, example embodiments may improve picture quality by adjusting elements affecting picture quality according to a degree of color vision deficiency.

In the figures, the dimensions of regions may be exaggerated for clarity of illustration. It will also be understood that when an element is referred to as being “on” another element or substrate, it can be directly on the other element or substrate, or intervening elements may also be present. Further, it will be understood that when a element is referred to as being “under” another element, it can be directly under, and one or more intervening elements may also be present. In addition, it will also be understood that when an element is referred to as being “between” two elements, it can be the only layer between the two elements, or one or more intervening elements may also be present. Like reference numerals refer to like elements throughout.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a display device, comprising:
receiving an input signal from a user;
determining whether the input signal is in a normal state or a degree of color deficiency; and
changing a gamma coefficient of the input signal according to the user's state.

2. The method as claimed in claim 1, wherein if the degree of color vision deficiency of the user is normal, setting the gamma coefficient of a first color, a gamma coefficient of a second color, and a gamma coefficient of a third color as basic gamma coefficients, and gamma-correct the input signal.

3. The method as claimed in claim 2, wherein the basic gamma coefficient is set to 2.2.

4. The method as claimed in claim 2, wherein if the degree of color vision deficiency of the user is not normal, changing at least one of the gamma coefficient of a first color, the gamma coefficient of a second color, and the gamma coefficient of a third color depending on the degree of color vision deficiency.

5. The method as claimed in claim 1, wherein if the degree of color vision deficiency is a first color weakness, changing the gamma coefficient of a first color to a higher value.

6. The method as claimed in claim 5, wherein changing the gamma coefficient includes multiplying the gamma coefficient by a first color multiplier.

7. The method as claimed in claim 5, wherein the gamma coefficient of the first color includes one of a red gamma coefficient, a green gamma coefficient, and a blue gamma coefficient.

8. The method as claimed in claim 1, wherein if the degree of color vision deficiency is a first color blindness, changing the gamma coefficient of a first color to a higher value.

9. The method as claimed in claim 8, wherein changing the gamma coefficient includes adding a first color offset to the gamma coefficient.

10. The method as claimed in claim 8, wherein the gamma coefficient of the first color includes one of a red gamma coefficient, a green gamma coefficient, and a blue gamma coefficient.

11. The method as claimed in claim 1, further comprising transmitting a gamma table selection signal to one least one of a plurality of gamma tables.

12. A display device, comprising:
a display panel adapted to display a video signal;
a driver adapted to drive the display panel; and
a controller adapted to receive an input signal from a user so as to determine whether the input signal is in a normal state or a degree of color in deficiency, and to change a gamma coefficient of the input signal according to the user's state.

13. The display device as claimed in claim 12, wherein the controller further comprises:
a user signal determination unit adapted to receive the input signal to determine the normal state or the degree of color vision deficiency;
a gamma setting unit adapted to correct the gamma coefficient according to the result of determination of the user signal determination unit, and adapted to set the gamma coefficient; and
a plurality of gamma tables adapted to gamma-correct the video signal to the set gamma coefficient, and adapted to output the same.

14. The display device as claimed in claim 13, wherein, if the degree of color vision deficiency of the user is normal, the gamma setting unit sets a gamma coefficient of a first color, a gamma coefficient of a second color, and a gamma coefficient of a third color as basic gamma coefficients.

15. The display device as claimed in claim 14, wherein the basic gamma coefficient is set to 2.2.

16. The display device as claimed in claim 13, wherein if the degree of color vision deficiency of the user is not normal, the gamma setting unit changes at least one of the gamma coefficient of a first color, the gamma coefficient of a second color, and the gamma coefficient of a third color depending on the degree of color vision deficiency.

17. The display device as claimed in claim 16, wherein if the degree of color vision deficiency is a first color weakness, the gamma coefficient of the first color is changed to a higher value.

18. The display device as claimed in claim 17, wherein the changed gamma coefficient multiplies a first color multiplier to the gamma coefficient.

19. The display device as claimed in claim 17, wherein if the degree of color vision deficiency is a first color blindness, the gamma coefficient of the first color is changed to a higher value.

20. The display device as claimed in claim 19, wherein the changed gamma coefficient adds a first color offset to the gamma coefficient.

21. The display device as claimed in claim 17, wherein the gamma coefficient of the first color includes one of a red gamma coefficient, a green gamma coefficient, and a blue gamma coefficient.

22. The display device as claimed in claim 19, wherein the gamma coefficient of the first color includes one of a red gamma coefficient, a green gamma coefficient, and a blue gamma coefficient.

23. The display device as claimed in claim 12, wherein a plurality of gamma tables corresponding to the normal state and the color vision deficiency, respectively, are provided.
